(19) United States
(12) Patent Application Publication
(10) Pub. No.: US 2011/0019325 A1
(43) Pub. Date: Jan. 27, 2011

(54) PROTECTION APPARATUS OF LOAD CIRCUIT

(75) Inventor: Yoshihide Nakamura, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: YAZAKI CORPORATION, TOKYO (JP)

(21) Appl. No.: 12/934,034

(22) PCT Filed: Feb. 24, 2009
(86) PCT No.: PCT/JP2009/000798

§ 371 Date: Sep. 22, 2010

(30) Foreign Application Priority Data
Mar. 24, 2008 (JP) P2008-076451

(51) Int. Cl. H02H 5/04

(52) U.S. Cl. 361/93.8

(57) ABSTRACT

A protection apparatus of a load circuit sets a threshold temperature at a lower temperature than an allowed temperature of an electric wire for use in the load circuit, and estimates a temperature of the electric wire based on an ambient temperature, a load current and a time while the load current is flowing through the electric wire. Then, in the case where the estimated temperature has reached the threshold temperature, a semiconductor relay (S1) is broken. As a result, in the case where such an electric wire temperature has risen owing to an occurrence of an overcurrent, and the like, the circuit is surely protected at the point of time before the electric wire temperature reaches the allowed temperature. Therefore, a fuse used in a conventional load circuit becomes unnecessary.

### TECHNICAL FIELD

The present invention relates to a protection apparatus of a load circuit, which is for protecting the load circuit by breaking the load circuit instantaneously when an overcurrent flows through the load circuit as a result an electric wire temperature rises.

### BACKGROUND ART

A load circuit that supplies electric power to a load such as a bulb and a motor, which is mounted on a vehicle, includes a battery and an electronic switch (MOSFET and the like) provided between the battery and the load. Then, the battery, the electronic switch and the load are connected to one another through conductors including electric wires. Moreover, a control circuit for performing ON/OFF operations for the electronic switch is provided, and drive and stop signals outputted from the control circuit perform the ON/OFF operations for the electronic switch, and switch the drive and stop of the load.

In the load circuit as described above, a fuse is provided for protecting the load, the electric wires, the electronic switch and the like by breaking the circuit instantaneously when an overcurrent flows through the load (refer to Patent Citation 1).

In a conventional load circuit shown in FIG. 1, power supply-side terminals of loads 101 are connected to a battery VB through an automotive electronic control unit (ECU) 102 and a junction box (J/B) 103.

Then, a plurality of electronic switches Tr1 such as the MOSFETs are provided in the ECU 102. These electronic switches Tr1 are controlled to be ON/OFF by a control IC 104. Moreover, first fuses F1 are provided on an upstream side of the respective electronic switches Tr1. These first fuses F1 protect electric wires W101 on a downstream side thereof. In other words, the electric wires W101 provided on the downstream side of the first fuses F1 have an electric wire diameter (cross-sectional area) sufficient for enduring a breaking current of the first fuses F1.

Moreover, second fuses F2 are provided in the J/B 103. These second fuses F2 protect an electric wire W102 on a downstream side thereof. In other words, the electric wire W102 provided on the downstream side of the second fuses F2 has a diameter (cross-sectional area) sufficient for enduring a breaking current of the second fuses F2.

Here, for example, in the case where the bulbs are used as the loads 101, the fuses F1 and F2 are deteriorated by rush currents generated when the bulbs are turned ON and by repetition of ON/OFF of the bulbs. Then, in some cases, erroneous breakdown occurs in the fuses F1 and F2 owing to a deterioration of the fuses F1 and F2, which is caused by use thereof with time. In order to prevent an occurrence of such a trouble, fuses prepared considering a margin for a load current are selected. Specifically, fuses in which the breakdown currents are increased somewhat more than usual are used. As a result, it is necessary to use electric wires adaptable to characteristics of the fuses prepared considering the margin, and it has become difficult to reduce the diameter of the electric wires for use in the load circuit.

### [Patent Citation 1]

### US 2003/0202304 A1

### DISCLOSURE OF INVENTION

Nowadays, a request that the electric wires for use in the load circuit be miniaturized and thinned as much as possible is being enhanced. Meanwhile, as described above, in the conventional load circuit, the fuses for breaking the circuit in the case where the electric wire temperature has risen owing to the occurrence of the overcurrent are provided. Then, the fuses are prepared considering the margin in order to prevent the erroneous breakdown owing to the deterioration caused by the use thereof with time. Therefore, the conventional load circuit has a disadvantage that it is difficult to miniaturize and thin the electric wires.

The present invention has been made in order to solve the conventional problem as described above. It is an object of the present invention to provide a protection apparatus of a load circuit, which enables the thinning of the electric wires by using a switch circuit simulating the fuses.

In order to achieve the above-described object, a protection apparatus of a load circuit according to a first aspect of the present invention is a protection apparatus of a load circuit that supplies, to a load, electric power outputted from a power supply and drives the load, the protection apparatus being for breaking the load circuit when an electric wire temperature of the load circuit has risen, including: a timer that counts an elapsed time; a current detection device that detects a current flowing through an electric wire on a downstream side thereof; a switch device that switches connection and breaking of the electric power to the load circuit; a temperature estimation device that estimates the electric wire temperature based on a value of the current detected by the current detection device and on the elapsed time counted by the timer; and a breaking control device in which a threshold temperature is set at a value (for example, 50 degrees Celsius) lower than an allowed temperature (for example, 150 degrees Celsius) of the electric wire for use in the load circuit, the breaking control device breaking the switch device in a case where the current detected by the current detection device has become equal to or larger than a reference current value (for example, 20 amperes) and the estimated temperature has reached the threshold temperature.

With such a configuration, such a load current is detected by the current detection device, such a time while the current has flown through the electric wire is counted by the timer, and the electric wire temperature is estimated based on results of these. Then, in the case where the estimated temperature has exceeded the threshold temperature, the switch circuit is broken, and the circuit is protected. Hence, by the fact that the threshold temperature is set at the lower temperature than the allowed temperature of the electric wire, even in the case where the electric wire temperature has risen, the electric wire and the load can be protected by surely breaking the circuit before the risen temperature reaches the allowed temperature. Moreover, in the case where the current value is smaller than the preset reference current value, though the temperature estimation is performed, the switch device is not broken, but such a connection state thereof is maintained. Hence, an occurrence of a trouble that the circuit is broken at a normal current can be avoided.

Moreover, it is preferable that the breaking control device turn the switch device to a connection-enabled state in a case where the temperature estimated by the temperature estimation device has dropped to an ambient temperature or lower after the switch device was broken.

With such a configuration, the estimation of the electric wire temperature is continued even after the electric wire temperature exceeded the threshold temperature and the switch device was broken, and in the case where the electric wire temperature has dropped to the ambient temperature (for example, 25 degrees Celsius) or lower, the switch device is turned to the connection-enabled state. Hence, a phenomenon can be avoided, in which energization of the load circuit is resumed in a state where the electric wire temperature continues to be high. In such a way, the load circuit can be surely protected.

Moreover, it is preferable that the threshold temperature is set at a lower temperature than an allowed temperature of an electric wire of which diameter is thinner by one level than a diameter of the electric wire for use in the load circuit.

With such a configuration, an electric wire with a diameter thinner than that of a conventional case becomes usable, and the thinning and miniaturization of the electric wire can be achieved. Hence, miniaturization and space saving can be achieved as a whole. Furthermore, in the case of applying the protection apparatus to a load circuit mounted on a vehicle, enhancement of fuel consumption can be achieved.

Moreover, it is preferable that the threshold temperature be set at a temperature located between a minimum breaking temperature and maximum breaking temperature of a fuse to be used for protecting the electric wire for use in the load circuit in a range where the current reaches a current value equal to or larger than the reference current value.

With such a configuration, temperature characteristics simulating characteristics of the fuse used usually for protecting the electric wire of the load circuit can be set, and accordingly, an effect equivalent to that of the conventional fuse can be obtained.

Furthermore, an arithmetic expression when the breaking control device calculates the electric wire temperature is represented as,

[Math. 1]

T2=T1+I1²rR{1−exp(−t/CR)} (1)

[Math. 2]

T2=T1+I2²rR{exp(−t/CR)} (2)

It is preferable that the expression (1) is used at a time of heat generation, and that the expression (2) is used at a time of heat radiation. Here, T1 is an ambient temperature (degree Celsius), T2 is an estimated temperature of the electric wire (degree Celsius), I1 and I2 are energization currents (ampere), r is an electric wire conductor resistance (ohm), R is a thermal resistance (degree Celsius/watt), C is a heat capacity (joule/degree Celsius), and t is a time (second).

In such a configuration, the heat generation of the electric wire is calculated by using the expression (1), and the heat radiation of the electric wire is calculated by using the expression (2), whereby the estimated temperature of the electric wire is obtained. Therefore, it becomes possible to estimate the temperature with high accuracy.

In the protection apparatus of the load circuit according to the first aspect of the present invention, the temperature of the electric wire to which the load circuit is connected is estimated, and in the case where the estimated electric wire temperature has exceeded the threshold temperature, the switch circuit is broken, and the circuit is protected. Hence, in the case where the electric wire temperature has risen by the heat generation owing to the overcurrent, the circuit is surely broken before the electric wire temperature reaches the allowed temperature, and the electric wire and the load are protected. Moreover, unlike the conventional fuse, no deterioration occurs owing to repetition of a rush current. Therefore, it is not necessary to ensure the margin for the breaking temperature, and accordingly, the diameter of the electric wire can be reduced. Hence, miniaturization and weight reduction of the electric wire can be achieved Moreover, in the case where the protection apparatus is used for the vehicle, an effect of enhancing the fuel consumption of the vehicle can also be exerted.

### BRIEF DESCRIPTION OF DRAWINGS

FIG. 1 is a circuit diagram showing a configuration of a protection apparatus of a load circuit in a conventional example.

FIG. 2 is a circuit diagram showing a configuration of a protection apparatus of a load circuit according to an embodiment of the present invention.

FIG. 3 is a block diagram showing a detailed configuration of a switch circuit in the protection apparatus of the load circuit according to the embodiment of the present invention.

FIG. 4 is an explanatory chart showing temperature characteristics in the protection apparatus of the load circuit according to the embodiment of the present invention.

FIG. 5 is an explanatory chart showing temperature characteristics in the protection apparatus of the load circuit according to the embodiment of the present invention.

FIG. 6 is an explanatory chart showing temperature characteristics in the protection apparatus of the load circuit according to the embodiment of the present invention.

FIG. 7 is an explanatory chart showing temperature characteristics in the protection apparatus of the load circuit according to the embodiment of the present invention.

FIG. 8 is an explanatory chart showing temperature characteristics in the protection apparatus of the load circuit according to the embodiment of the present invention.

FIG. 9 is an explanatory chart showing temperature characteristics in the protection apparatus of the load circuit according to the embodiment of the present invention.

FIG. 10(a) and FIG. 10(b) are explanatory diagrams showing a procedure of calculating an electric wire temperature changed by heat generation and calculating an electric wire temperature changed by heat radiation in the protection apparatus of the load circuit according to the embodiment of the present invention.

FIG. 11(a) and FIG. 11(b) are explanatory diagrams showing a procedure of calculating an electric wire temperature changed by heat generation and calculating an electric wire temperature changed by heat radiation in the protection apparatus of the load circuit according to the embodiment of the present invention.

FIG. 12(a) and FIG. 12(b) are explanatory diagrams showing a procedure of calculating an electric wire temperature changed by heat generation and calculating an electric wire temperature changed by heat radiation in the protection apparatus of the load circuit according to the embodiment of the present invention.

FIG. 13(a) and FIG. 13(b) are explanatory diagrams showing a procedure of calculating an electric wire temperature changed by heat generation and calculating an electric wire temperature changed by heat radiation in the protection apparatus of the load circuit according to the embodiment of the present invention.

FIG. 14(a) and FIG. 14(b) are explanatory diagrams showing a procedure of calculating an electric wire temperature changed by heat generation and calculating an electric wire temperature changed by heat radiation in the protection apparatus of the load circuit according to the embodiment of the present invention.

FIG. 15(a) and FIG. 15(b) are explanatory diagrams showing a procedure of calculating an electric wire temperature changed by heat generation and calculating an electric wire temperature changed by heat radiation in the protection apparatus of the load circuit according to the embodiment of the present invention.

FIG. 16A is a flowchart showing processing operations of the protection apparatus of the load circuit according to the embodiment of the present invention.

FIG. 16B is a flowchart of the continuance of FIG. 16A.

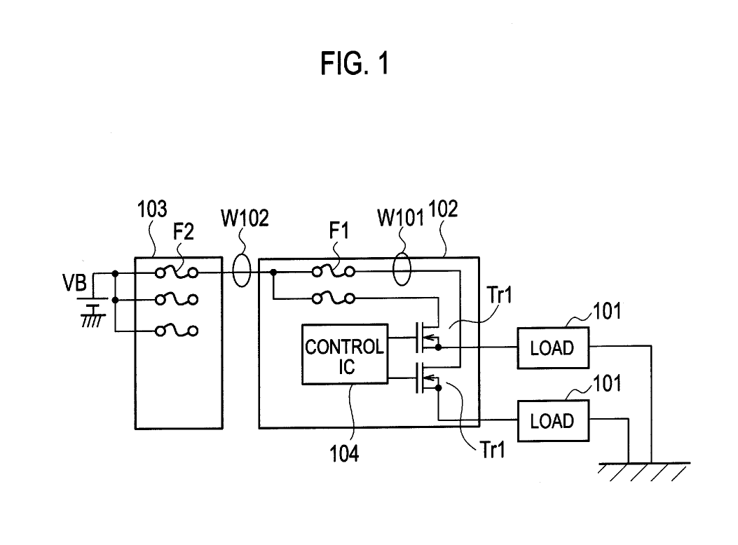

### BEST MODE FOR CARRYING OUT THE INVENTION

A description will be made below of an embodiment of the present invention based on the drawings.

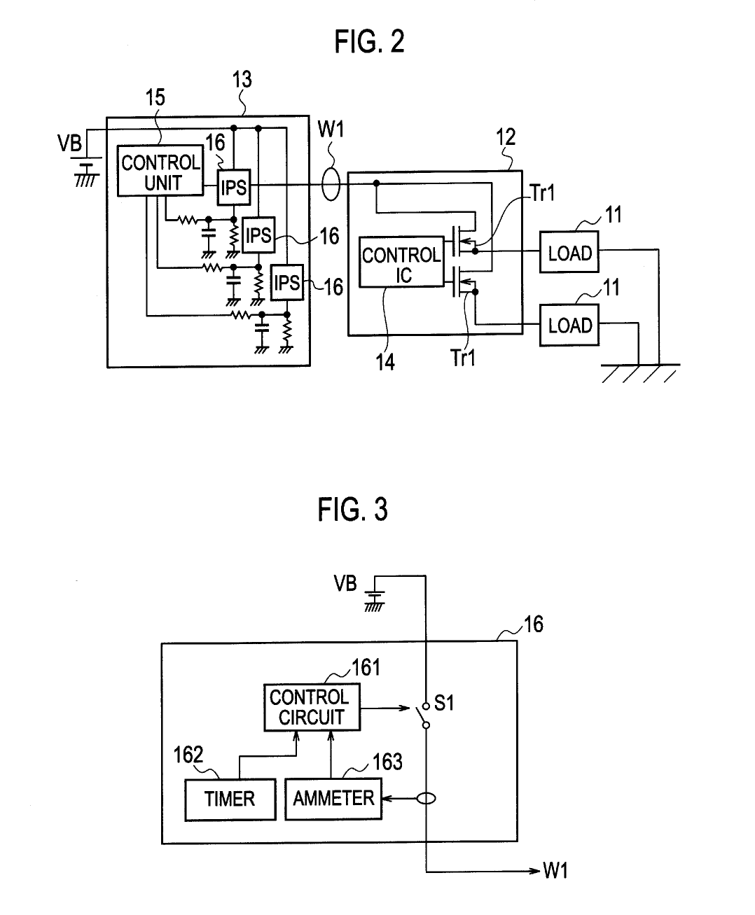

A load circuit shown in FIG. 2 supplies electric power, which is outputted from a battery (power supply) VB, to loads 11, for example, such as bulbs and motors, which are mounted on a vehicle, and controls drive and stop of the respective loads 11. This load circuit includes an automotive electronic control unit (ECU) 12, and a junction box (J/B) 13.

The ECU 12 includes a plurality of electronic switches Tr1 such as MOSFETs. One-side terminals of the respective electronic switches Tr1 are connected to the loads 11, and other-side terminals thereof are connected to the J/B 13 through an electric wire W1. Moreover, the ECU 12 includes a control IC 14. Then, ON/OFF of the respective electronic switches Tr1 are controlled by the control IC 14, and the drive and stop of the loads 11 are controlled following the ON/OFF of the electronic switches Tr1.

The J/B 13 includes a plurality of switch circuits (IPS) 16 which connect the electric wire W1 and the battery VB to each other. The switch circuits 16 operate under control of a control unit 15.

As shown in FIG. 3, each of the switch circuits 16 includes: a semiconductor relay (switch device) S1; an ammeter 163 that detects a current flowing through the electric wire W1; a timer 162 that counts an elapsed time while the current is flowing through the electric wire W1; and a control circuit 161 that controls ON/OFF of the semiconductor relay S1 based on a value of the current detected by the ammeter 163 and on the time counted by the timer 162.

In a protection apparatus of the load circuit according to this embodiment, the control circuit (temperature estimation device, breaking control device) 161 estimates a temperature of the electric wire W1 by using a method to be described later. Then, in the case where the estimated temperature of the electric wire W1 has reached a predetermined threshold temperature (for example, 50 degrees Celsius), the control circuit 161 breaks an upstream side of the electric wire W1. As a result, the electric wire W1, and the respective switches Tr1 and the respective loads 11, which are provided on a downstream side of the electric wire W1, are protected.

A description will be made below in detail of the method of estimating the temperature of the electric wire W1. An expression (1) shown below is a general expression that represents an electric wire temperature at the time of heat generation. Moreover, an expression (2) is a general expression that represents an electric wire temperature at the time of heat radiation.

[Math. 3]

T2=T1+I1²rR{1−exp(−t/CR)} (1)

[Math. 4]

T2=T1+I2²rR{exp(−t/CR)} (2)

Here, T1 is an ambient temperature (degree Celsius), T2 is the estimated temperature of the electric wire (degree Celsius), I1 and I2 are energization currents (ampere), r is an electric wire conductor resistance (ohm), R is a thermal resistance (degree Celsius/watt), C is a heat capacity (joule/degree Celsius), and t is a time (second). Note that, for the above-described ambient temperature T1, a method of assigning an atmospheric temperature that is based on an environment where the circuit is provided, a method of placing a thermometer (not shown) and assigning a temperature detected by the thermometer, or the like can be used.

Hence, the ambient temperature T1, the current I1 and the time t are assigned to the expression (1), whereby the estimated temperature T2 of the electric wire W1 at the time of heat generation is obtained. Moreover, the ambient temperature T1, the current I2 and the time t are assigned to the expression (2), whereby the estimated temperature T2 of the electric wire W1 at the time of heat radiation is obtained.

Then, if the switch circuit 16 is broken at the point of time when the estimated temperature T2 reaches a predetermined threshold temperature, then the whole of the load circuit including the electric wire W1 can be protected. For example, in the case where the allowed temperature of the electric wire W1 is 150 degrees Celsius, if the threshold temperature is preset at 50 degrees Celsius as a lower temperature than 150 degrees Celsius concerned, then the circuit is broken at the point of time before the electric wire W1 reaches the allowed temperature to cause smoking owing to heat generation by an overcurrent, whereby the whole of the load circuit including the electric wire W1 can be protected. Hence, if the protection apparatus of the load circuit according to this embodiment is used, then the temperature rise is surely sensed and the circuit is broken without providing any fuse on the upstream side of the respective load circuits as in the conventional case, whereby the circuit can be protected.

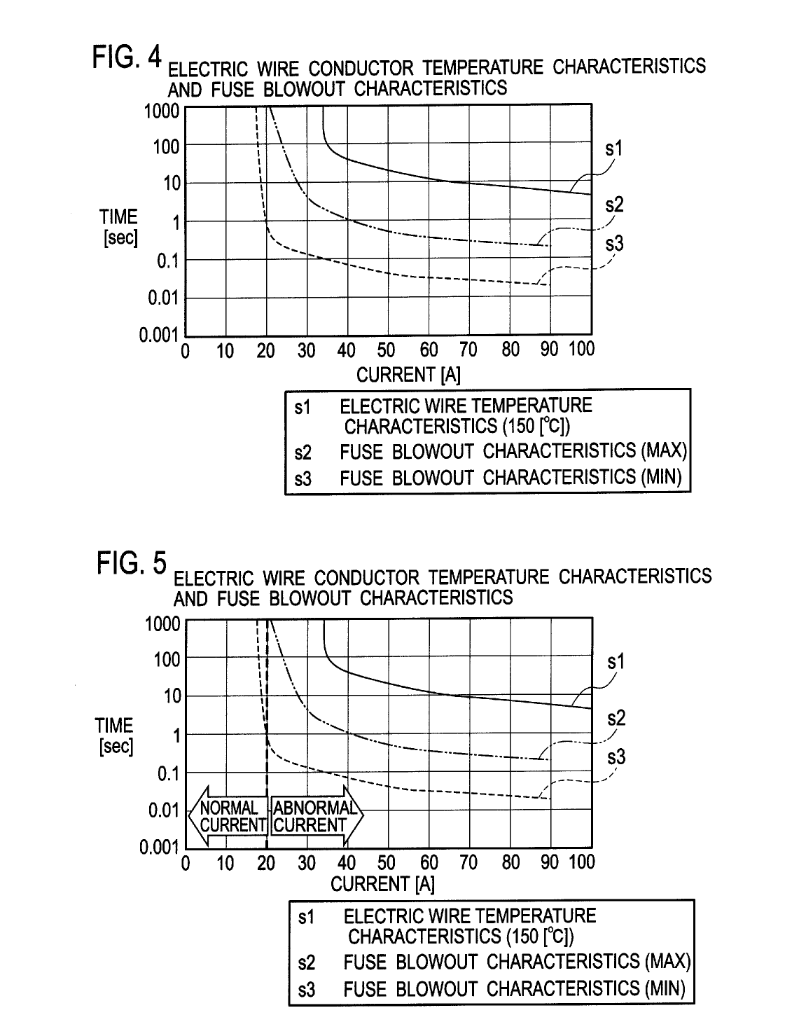

In this embodiment, the circuit is protected by providing the switch circuit 16 in place of the fuse used heretofore. Therefore, it is desired that the switch circuit 16 include temperature characteristics simulating the fuse. Accordingly, in this embodiment, the temperature characteristics of the switch circuit 16 are set in procedures shown in characteristic charts of FIG. 4 to FIG. 9. A description will be made below of the procedures of setting the temperature characteristics of the switch circuit 16 with reference to FIG. 4 to FIG. 9.

A curve s1 shown in FIG. 4 is a characteristic chart showing current/time characteristics when the allowed temperature is set at 150 degrees Celsius. Specifically, the curve s1 shows a relationship between the current I1 and the elapsed time t (second) on a right side of the above-described expression (1) when T2 on a left side thereof is fixed to 150 degrees Celsius. As understood from the curve s1, in the case where the allowed temperature (temperature at which smoking occurs by overheat) of the electric wire is 150 degrees Celsius, the electric wire temperature does not reach 150 degrees Celsius in the case where a current of 50 amperes flows therethrough for 10 seconds, however the electric wire temperature reaches 150 degrees Celsius in the case where a current of 90 amperes flows therethrough for 10 seconds, for example. Specifically, if the circuit operates at a current value on an inside of the curve s1 (lower-left side in the chart), then the electric wire temperature does not reach 150 degrees Celsius as the allowed temperature.

Moreover, curves s2 and s3 are breaking temperature characteristic curves of a fuse with a general standard, which is provided on the upstream side of the electric wire in which the allowed temperature is 150 degrees Celsius. Here, the curve s2 shows a maximum value (MAX) of such breaking temperature characteristics, and the curve s3 shows a minimum value (MIN) thereof. Specifically, when a current within a range between the curves s2 and s3 flows through this fuse, the fuse is broken, and protects the circuit. Hence, by using this fuse, the circuit can be surely broken at the point of time before the electric wire temperature reaches 150 degrees Celsius. Hence, if the switch circuit 16 is configured to include temperature characteristics between the curves s2 and s3, then characteristics of the fuse used heretofore can be simulated.

FIG. 5 shows that the current flowing through the electric wire is defined as a normal current in the case of being lower than 20 amperes, and that the current concerned is defined as an abnormal current in the case of being equal to or higher than 20 amperes. Then, a setting is made so that the switch circuit 16 cannot be broken regardless of the electric wire temperature in the case where the current flowing through the electric wire is the normal current (less than 20 amperes).

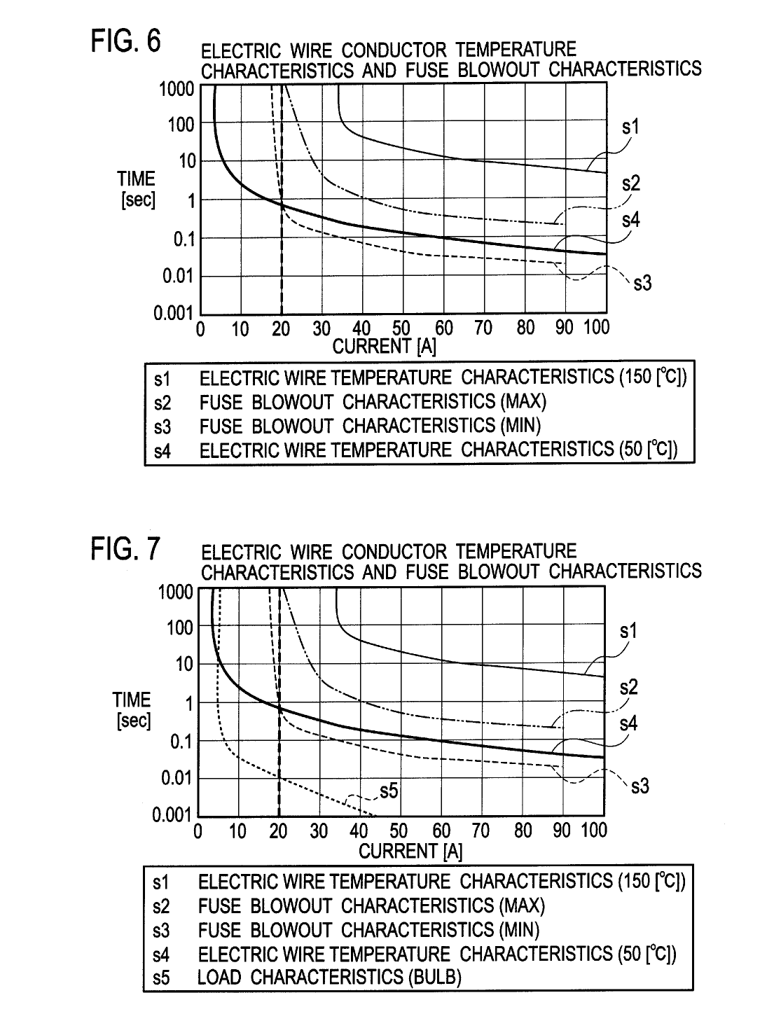

As an example of temperature characteristics located between the curves s3 and s4 shown in FIG. 4 and FIG. 5, FIG. 6 shows a temperature characteristic curve s4 in the case where the allowed temperature is set at 50 degrees Celsius. Specifically, the curve s4 shows a relationship between the current I1 and the elapsed time t (second) on the right side of the above-mentioned expression (1) when T2 on the left side thereof is fixed to 50 degrees Celsius. Then, as understood from FIG. 6, the curve s4 becomes a curve passing through a region between the curve s2 showing the maximum value of the temperature characteristics of the fuse and the curve s3 showing the minimum value thereof in a range where the current is equal to or larger than 20 amperes. Specifically, it is understood that, in the range where the current is equal to or larger than 20 amperes, if the electric wire temperature owing to the heat generation and the electric wire temperature owing to the heat radiation are calculated by using the expressions (1) and (2), and the switch circuit 16 is broken at the point of time when the electric wire temperature (that is, T2) reached 50 degrees Celsius, then an affect equivalent to that of the fuse can be obtained.

FIG. 7 further writes thereinto a curve s5 showing load characteristics in addition to the variety of characteristic curves shown in FIG. 6. Then, as understood from FIG. 7, the curves s4 and s5 intersect each other in a low-current range. Therefore, when the temperature characteristic curve s4 of 50 degrees Celsius is used, the switch circuit 16 is broken at the normal current in the low-temperature range.

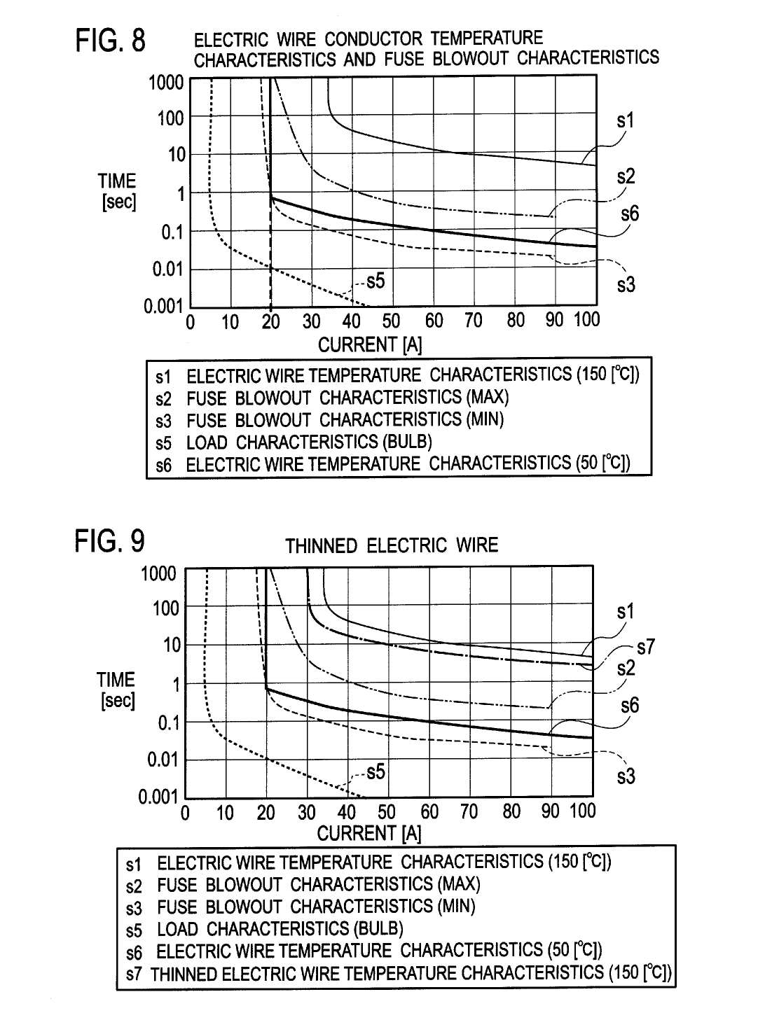

FIG. 8 shows a temperature characteristic curve s6 of 50 degrees Celsius as the allowed temperature when a setting is made so that the switch circuit 16 cannot be broken in a range where the current is smaller than 20 amperes. By making the setting as described above, the curve s6 and the curve s5 do not intersect each other, and the curve s6 is located within a range between the curves s2 and s3. Specifically, in the range where the current is smaller than 20 amperes (reference current value), the switch circuit 16 is not broken, and in a range where the current is equal to or larger than 20 amperes, the temperature characteristic curve of 50 degrees Celsius is used, whereby characteristics equivalent to those of the fuse can be obtained.

FIG. 9 shows that a diameter of the electric wire can be reduced more than that of the conventional case by the fact that the switch circuit 16 is capable of breaking the circuit in accordance with the temperature characteristics shown by the curve s6. Specifically, by using the switch circuit 16 including the temperature characteristics as shown by the curve s6, for example, an electric wire with an allowed temperature shown by a curve S7, which is lower than the allowed temperature shown by the curve s1, can be used without any trouble even if the electric wire with the allowed temperature shown by the curve s1 is changed to the electric wire with such a lower allowed temperature shown by the curve S7. Specifically, in the protection apparatus of the load circuit according to this embodiment, the diameter of the electric wire can be reduced by using the switch circuit 16 including the temperature characteristics equivalent to those of the conventional fuse.

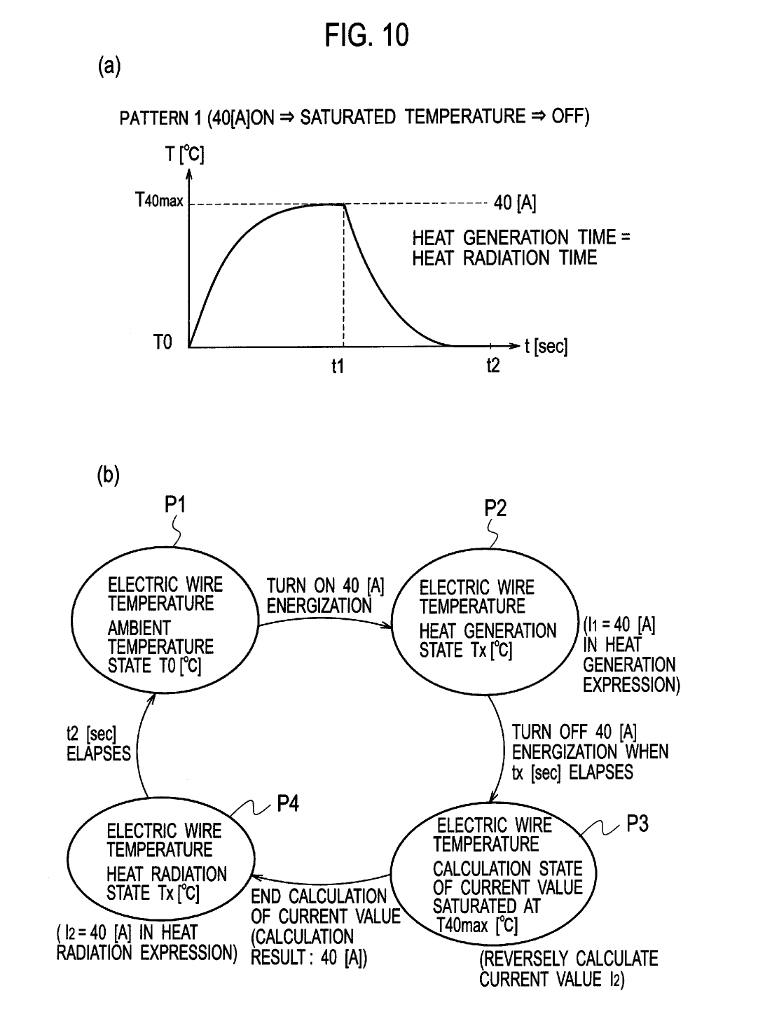

Next, a description will be made of patterns 1 to 6 shown in FIG. 10 to FIG. 15, which are related to procedures of calculating the electric wire temperature at the time of heat generation by the above-described expression (1) and calculating the electric wire temperature at the time of heat radiation by the above-described expression (2).

### (Pattern 1)

FIG. 10(a) is a characteristic chart showing a temperature change of the electric wire in the case where the electric wire temperature is saturated at a constant current (40 amperes), and the current is thereafter broken radiating heat. Moreover, FIG. 10(b) is an explanatory diagram showing a change of the state. First, the current of 40 amperes flows through the electric wire in a state where an initial temperature is T0 as the ambient temperature (state P1). Then, the electric wire temperature gradually rises from the temperature T0 (state P2), and reaches T40max as the saturated temperature at the current of 40 amperes at a time tx=t1. Specifically, T0 is assigned to the ambient temperature T1 on the right side of the above-described expression (1), 40 amperes is assigned to the current I1 on the right side concerned, and t1 is assigned to the time t on the right side. Then, the estimated temperature T2 of the electric wire owing to the heat generation rises along a curve shown by FIG. 10(a), and reaches the saturated temperature T40max at the time t1.

When the current is thereafter broken, the current value saturated at the electric wire temperature T40max is reversely calculated since the electric wire temperature at this time is T40max (state P3). As a result, the current value I2 is obtained as 40 amperes. Then, the ambient temperature is assigned to T1 shown in the expression (2), and the obtained current value I2 and elapsed time t are further assigned to the corresponding items in the expression (2), whereby the estimated temperature T2 of the electric wire owing to the heat radiation is obtained (state P4).

Specifically, in the case where the current is broken after the current of 40 amperes flowed through the electric wire and the temperature of the electric wire has reached the saturated temperature T40max of this current 40 amperes, 40 amperes is assigned to the current I2 shown in the right side of the expression (2), whereby the electric wire temperature at the time of heat radiation is obtained.

### (Pattern 2)

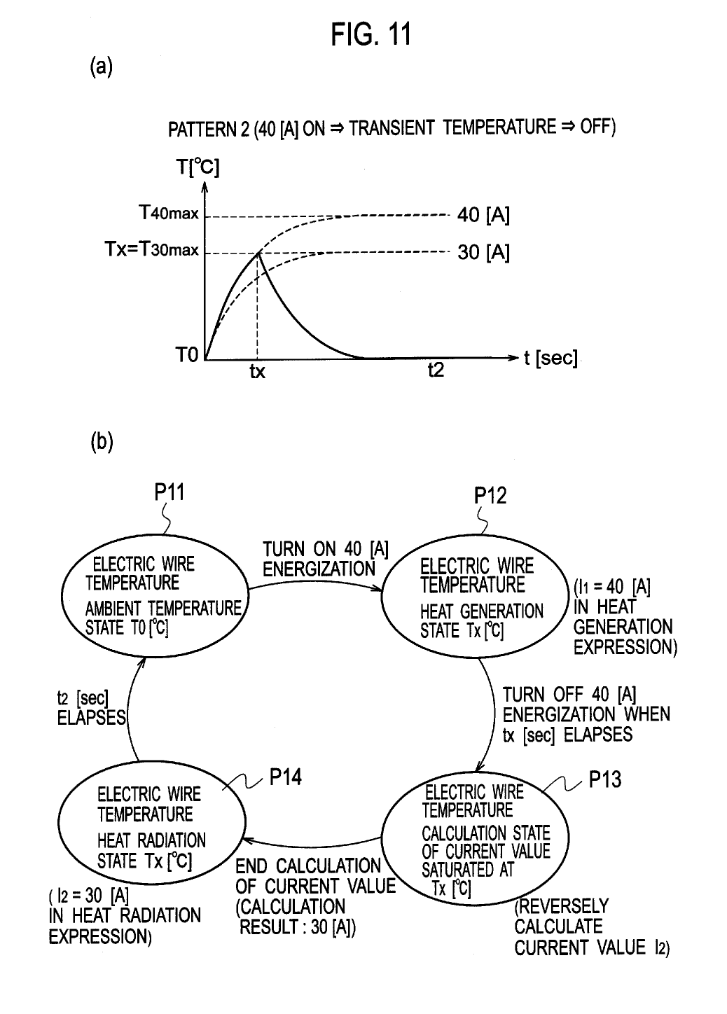

FIG. 11(a) is a characteristic chart showing a temperature change of the electric wire in the case where the electric wire temperature has risen at a constant current (40 amperes), and in a transient state before the electric wire temperature reaches the saturated temperature T40max, the current is broken radiating the heat. Moreover, FIG. 11(b) is an explanatory diagram showing a change of the state. First, the current of 40 amperes flows through the electric wire in a state where the initial temperature is T0 as the ambient temperature (state P11). Then, the electric wire temperature gradually rises from the temperature T0 (state P12). Then, in the case where the energization of the current 40 amperes is broken at a time tx, that is, in the case where the current is broken at a transient temperature before the electric wire temperature reaches the saturated temperature T40max by the energization of 40 amperes, a temperature Tx by the heat generation at this time is obtained, and the current value I2 at which this temperature Tx becomes the saturated temperature is reversely calculated (state P13). For example, in the case where the electric wire temperature Tx at the time tx is a saturated temperature T30max when a current 30 amperes flows, 30 amperes is assigned to the current I2 on the right side of the expression (2), and the ambient temperature is further assigned to T1 on the right side, and the elapsed time is further assigned to t on the right side, whereby the estimated temperature T2 of the electric wire owing to the heat radiation is obtained (state P14).

Specifically, in the case where the current of 40 amperes flows, and the current is broken before the electric wire temperature reaches the saturated temperature T40max at the current of 40 amperes, the current saturated at the temperature when the current is broken is obtained. Then, this current is assigned to the corresponding item on the right side of the expression (2), whereby the electric wire temperature in the case of radiating the heat is obtained.

### (Pattern 3)

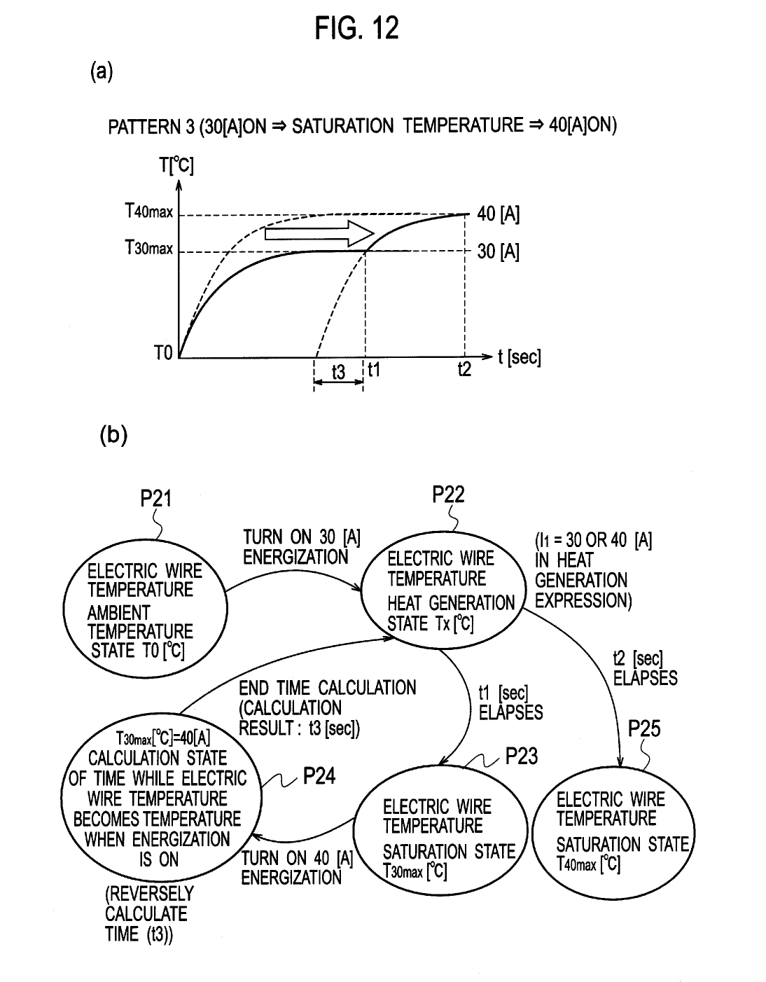

FIG. 12(a) is a characteristic chart showing a temperature change of the electric wire in the case where the electric wire temperature reaches the saturated temperature by a first current (for example, 30 amperes), and the electric wire temperature further reaches the saturated temperature by a second current (for example, 40 amperes) larger than the first current. Moreover, FIG. 12(b) is an explanatory view showing a change of the state. First, the current of 30 amperes flows through the electric wire in a state where the initial temperature is T0 as the ambient temperature (state P21). Then, the electric wire temperature Tx gradually rises from the temperature T0 (state P22), and reaches the saturated temperature T30max at the time t1 (state P23).

In the case where the current is changed to 40 amperes in this state, an elapsed time t3 in the case of assuming that the electric wire temperature has reached T30max as a result of that the current of 40 amperes flowed from the beginning is reversely calculated (state P24). Then, 40 amperes is assigned to the current I1 on the right side of the expression (1), and the above-described t3 is assigned to the time t, and the estimated temperature T2 until the time elapses to the time t2 is obtained (state P22 one more time). Then, at the time t2, the electric wire temperature reaches the saturated temperature T40max at the current of 40 amperes (state P25).

Specifically, first, the current of 30 amperes flows, and the electric wire temperature reaches the saturated temperature T30max at the current of 30 amperes. Thereafter, in the case where the current is changed to 40 amperes, the elapsed time in the case of assuming that the current of 40 amperes has flown from the beginning, that is, the time t3 shown in FIG. 12(a) is calculated. Then, the time t3 is assigned to the corresponding item of the expression (1), and the electric wire temperature is obtained.

### (Pattern 4)

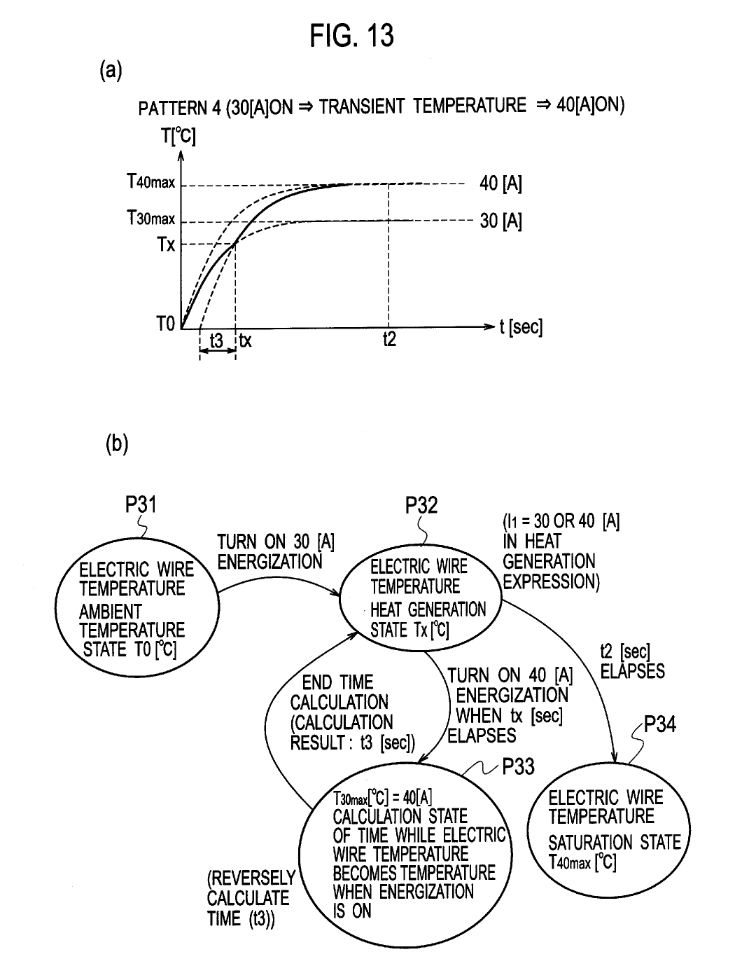

FIG. 13(a) is a characteristic chart showing a temperature change of the electric wire in the case where the electric wire temperature has risen by the first current (for example, 30 amperes), the first current is changed to the second current (for example, 40 amperes) larger than the first current before the electric wire temperature reaches the saturated temperature T30max by the first current, and the electric wire temperature reaches the saturated temperature T40max at the second current. Moreover, FIG. 13(b) is an explanatory view showing a change of the state. First, when the initial temperature is T0 as the ambient temperature (state P31), and the current of 30 amperes flows through the electric wire, the electric wire temperature Tx gradually rises from the temperature T0 (state P32). Then, when the electric wire temperature reaches Tx at the time tx, the current is changed to 40 amperes. Then, the elapsed time t3 in the case of assuming that the current of 40 amperes has flown from the beginning and the electric wire temperature has reached Tx is reversely calculated (state P33). Then, 40 amperes is assigned to the current I1 on the right side of the expression (1), and the above-described t3 is assigned to the time t on the right side, and the estimated temperature T2 until the time elapses to the time t2 is obtained (state P32 one more time). Then, at the time t2, the electric wire temperature reaches the saturated temperature T40max at the current of 40 amperes (state P34).

Specifically, in the case where the current is changed to 40 amperes at the point of time when the electric wire temperature reached the temperature Tx before reaching the saturated temperature at the current of 30 amperes as a result of that the current of 30 amperes flowed, the elapsed time in the case of assuming that the current of 40 amperes has flown from the beginning, that is, the time t3 shown in FIG. 13(a) is calculated. Then, the time t3 is assigned to the corresponding item of the expression (1), and the electric wire temperature is obtained.

### (Pattern 5)

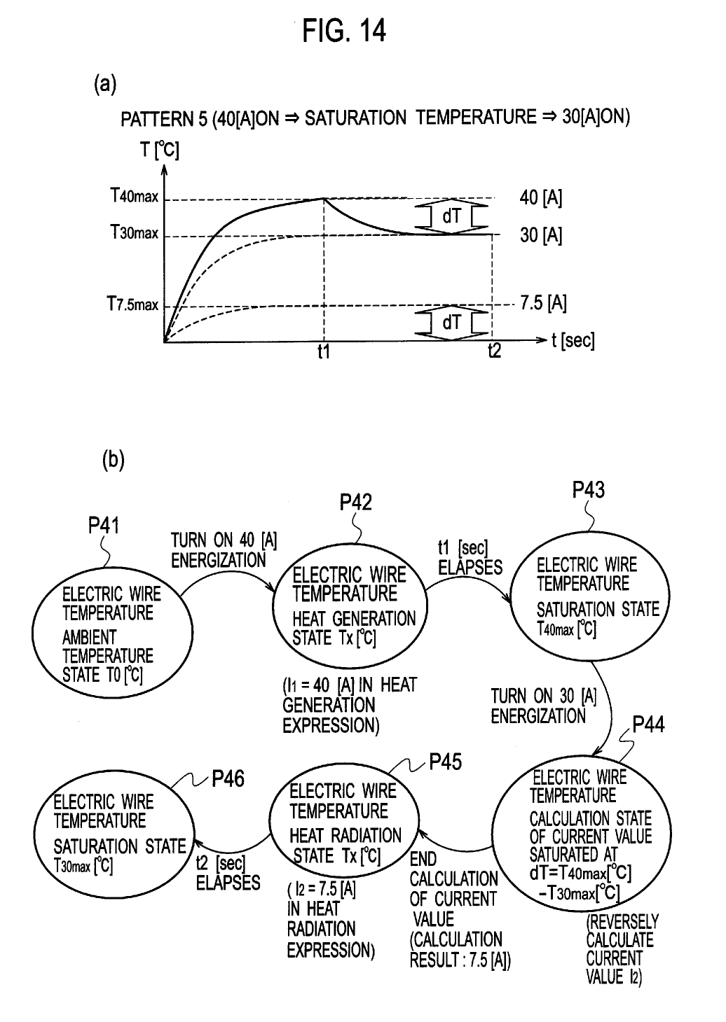

FIG. 14(a) is a characteristic chart showing a temperature change of the electric wire in the case where the electric wire temperature reaches the saturated temperature T40max at the first current by the first current (for example, 40 amperes), and the electric wire temperature drops to the saturated temperature T30max at the second current smaller than the first current by the second current (for example, 30 amperes). Moreover, FIG. 14(b) is an explanatory view showing a change of the state. First, the current of 40 amperes flows through the electric wire when the initial temperature is T0 as the ambient temperature (state P41). Then, the electric wire temperature Tx gradually rises from the temperature T0 (state P42), and reaches the saturated temperature T40max at the time t1 (state P43).

In the case where the current is changed to 30 amperes in this state, a difference dT (dT=T40max−T30max) between the saturated temperature T40max at the current of 40 amperes and the saturated temperature T30max at the current of 30 amperes is obtained. Then, the saturated current value I2 is calculated from the temperature difference dT (state P44). As a result, for example, in the case where the current value I2 becomes equal to 7.5 amperes, 7.5 amperes is assigned to I2 on the right side of the expression (2), and the estimated temperature T2 of the electric wire owing to the heat radiation is obtained (state P45). Thereafter, after the elapse of the time t2, the electric wire temperature reaches the saturated temperature T30max of the time when the current of 30 amperes flows (state P46).

Specifically, first, the current of 40 amperes flows, and the electric wire temperature reaches the saturated temperature T40max at the current of 40 amperes. Thereafter, in the case where the current is changed to 30 amperes, the difference dT between the respective saturated temperatures is obtained, and the current value I2 saturated at this temperature difference dT is calculated. Then, this current value I2 is assigned to the corresponding item of the expression (2), whereby the electric wire temperature is obtained.

### (Pattern 6)

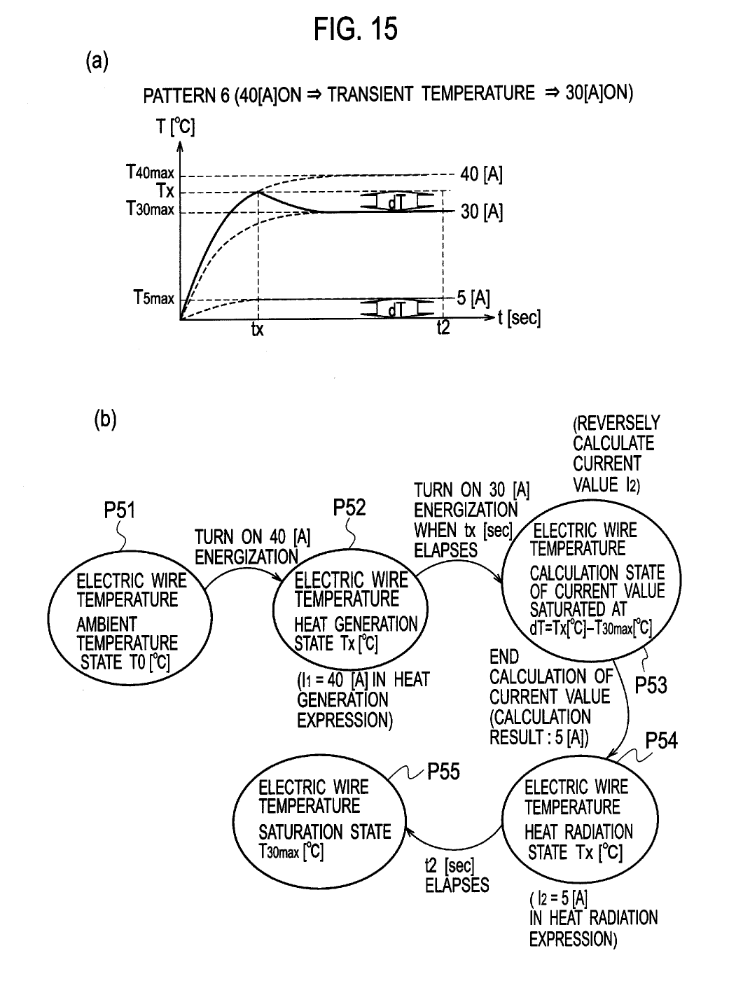

FIG. 15(a) is a characteristic chart showing a temperature change of the electric wire in the case where the electric wire temperature has risen by the first current (for example, 40 amperes), the first current is changed to the second current (for example, 30 amperes) smaller than the first current when the electric wire temperature reaches the temperature Tx before reaching the saturated temperature T40max at the first current, and the electric wire temperature drops to reach the saturated temperature T30max at the second current. Moreover, FIG. 15(b) is an explanatory view showing a change of the state. First, the current of 40 amperes flows through the electric wire when the initial temperature is T0 as the ambient temperature (state P51). Then, the electric wire temperature Tx gradually rises from the temperature T0 (state P52). Then, when the current is changed to 30 amperes when the electric wire temperature has reached Tx at the time tx, a temperature difference dT (dT=Tx−T30max) between the temperature Tx and the saturated temperature T30max of the time when the current of 30 amperes flows is obtained, and the current value I2 saturated at this temperature difference dT is calculated (state P53). As a result, for example, in the case where the current value I2 becomes equal to 5 amperes, 5 amperes is assigned to I2 on the right side of the expression (2), and the estimated temperature T2 of the electric wire owing to the heat radiation is obtained (state P54). Thereafter, after the elapse of the time t2, the electric wire temperature reaches the saturated temperature T30max of the time when the electric wire is energized with the current of 30 amperes (state P55).

Specifically, in the case where the current is changed to 30 amperes at the point of time when the electric wire temperature reaches the temperature Tx before reaching the saturated temperature T40max at the current of 40 amperes as a result of that the current of 40 amperes has flowed, the difference dT between the temperature Tx and the saturated temperature T30max of the time when the electric wire is energized with the current of 30 amperes is calculated, and the current value I2 saturated at this temperature difference dT is calculated. Then, this current value I2 is assigned to the corresponding item of the expression (2), whereby the electric wire temperature is obtained.

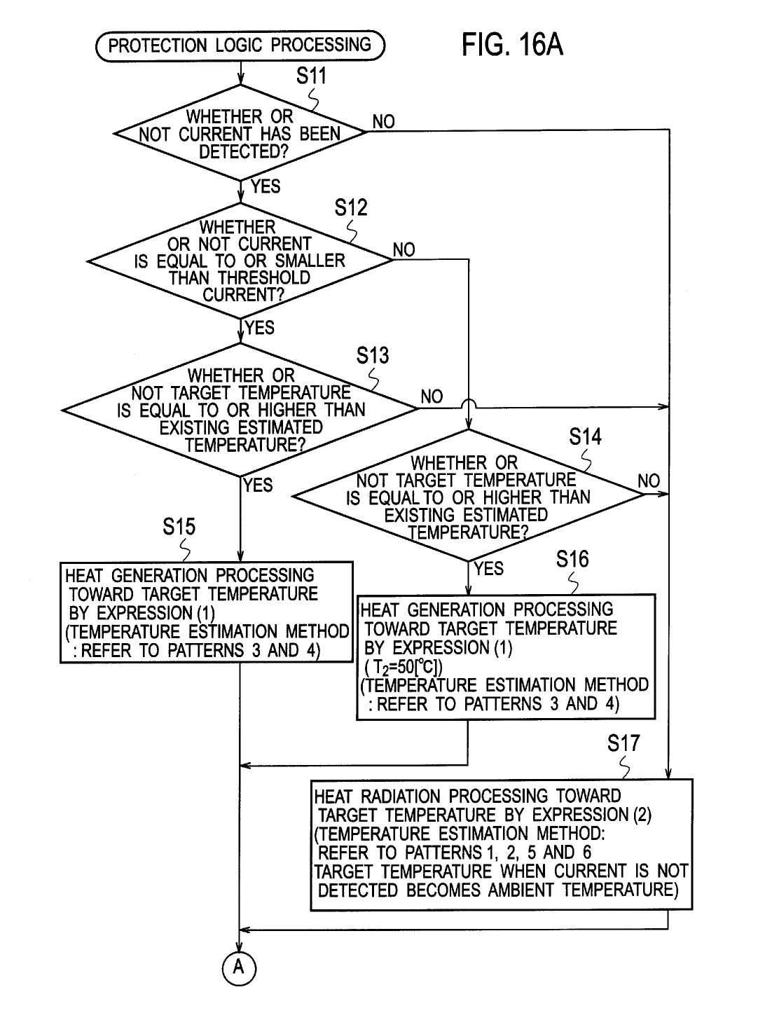

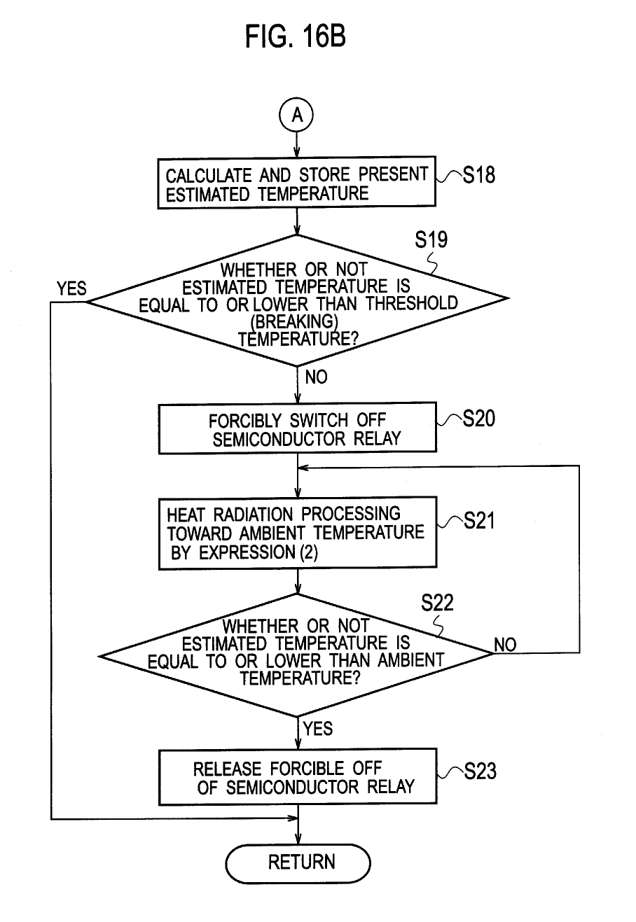

Next, a description will be made of processing operations of the protection apparatus of the load circuit according to this embodiment with reference to a flowchart shown in FIGS. 16A and 16B. Note that a series of processings shown in FIGS. 16A and 16B are executed repeatedly in a predetermined sampling cycle.

First, in processing of Step S11, the control circuit 161 of the switch circuit 16 shown in FIG. 3 determines whether or not the current is detected by the ammeter 163. Specifically, the control circuit 161 determines whether or not the current is flowing through the loads 11 shown in FIG. 2. Then, in the case of having determined that the current is flowing through the loads 11 (YES in Step S11), the processings proceed to Step S12. Meanwhile, in the case of having determined that the current is not flowing through the loads 11 (NO in Step S11), the processings proceed to Step S17.

In Step S12, the control circuit 161 determines whether or not the current detected by the processing of Step S11 is equal to or smaller than a preset threshold current (for example, 20 amperes). Then, in the case where the current is equal to or smaller than the threshold current (YES in Step S12), the processings proceed to Step S13. Meanwhile, in the case where the current is not equal to or smaller than the threshold current (NO in Step S12), the processings proceed to Step S14.

In Step S13, the control circuit 161 determines whether or not a target temperature (saturated temperature in the case where the current with a present value continues to flow) of the present current value is equal to or higher than the existing estimated temperature (target temperature at the time of the previous sampling). Then, in the case of having determined that the target temperature is equal to or higher than the existing estimated temperature (YES in Step S13), the processings proceed to Step S15. Meanwhile, in the case of having determined that the target temperature is not equal to or higher than the existing estimated temperature (NO in Step S13), the processings proceed to Step S17.

In Step S14, the control circuit 161 determines whether or not the target temperature (saturated temperature in the case where the current with a present value continues to flow) of the present current value is equal to or higher than the existing estimated temperature (target temperature at the time of the previous sampling). Then, in the case of having determined that the target temperature is equal to or higher than the existing estimated temperature (YES in Step S14), the processings proceed to Step S16. Meanwhile, in the case of not having determined that the target temperature is equal to or higher than the existing estimated temperature (NO in Step S14), the processings proceed to Step S17.

In Step S15, the control circuit 161 executes heat generation processing toward the target temperature by the expression (1). In this case, the temperature estimation methods shown in the above-mentioned patterns 3 and 4 are used. In the case where this processing is ended, the processings proceed to Step S18.

In Step S16, the control circuit 161 executes heat generation processing (T2=50 degrees Celsius) toward the target temperature by the expression (1). In this case, the temperature estimation methods shown in the above-mentioned patterns 3 and 4 are used. In the case where this processing is ended, the processings proceed to Step S18.

In Step S17, the control circuit 161 executes heat radiation processing toward the target temperature by the expression (2). In this case, the temperature estimation methods shown in the above-mentioned patterns 1, 2, 5 and 6 are used. Moreover, the ambient temperature is defined as the target temperature in the case where the current is not detected. In the case where this processing is ended, the processings proceed to Step S18.

In Step S18, the control circuit 161 calculates the present estimated temperature of the electric wire W1 based on temperatures obtained by the processings of Steps S15, S16 and S17. Moreover, the calculated estimated temperatures are stored in a memory (not shown) and the like. In the case where this processing is ended, the processings proceed to Step S19.

In Step S19, the control circuit 161 determines whether or not the estimated temperature calculated in the processing of Step S18 is equal to or lower than a set protection temperature. The set protection temperature is set, for example, at 50 degrees Celsius. Then, in the case where the estimated temperature is equal to or lower than the set protection temperature (YES in Step S19), the processings return to Step S11. Meanwhile, in the case where the estimated temperature is not equal to or lower than the set protection temperature (NO in Step S19), the processings proceed to Step S20.

In Step S20, the control circuit 161 forcibly switches OFF the semiconductor relay s1 shown in FIG. 3. In the case where this processing is ended, the processings proceed to Step S21. Specifically, in the case where the estimated temperature of the electric wire is equal to or higher than the threshold temperature, the control circuit 161 breaks the semiconductor relay S1, and protects the circuit.

In Step S21, the control circuit 161 executes heat radiation processing in which the ambient temperature is defined as the target temperature by using the expression (2). Specifically, even in the case where the semiconductor relay S1 is switched OFF, the electric wire W1 radiates the heat, and accordingly, a heat radiation temperature in this case is obtained. In the case where this processing is ended, the processings proceed to Step S22.

In Step S22, the control circuit 161 determines whether or not the estimated temperature has dropped to the ambient temperature or lower. Then, in the case where the estimated temperature has dropped to the ambient temperature or lower (YES in Step S22), the processings proceed to Step S23. Meanwhile, in the case where the estimated temperature has not dropped to the ambient temperature or lower (NO in Step S22), the processings return to Step S21.

In Step S23, the control circuit 161 releases such forcible OFF of the semiconductor relay S1. Specifically, in the case where the estimated temperature of the electric wire W1 has dropped to the ambient temperature or lower, no problem occurs even if the current is flown through the electric wire W1 one more time. Accordingly, the forcible OFF of the semiconductor relay S1 is released. In the case where this processing is ended, the processings return to Step S11.

As described above, in the protection apparatus of the load circuit according to this embodiment, the temperature of the electric wire W1 is estimated by using the expressions (1) and (2). Then, in the case where this estimated temperature has reached the threshold temperature (for example, 50 degrees Celsius), the control circuit 161 breaks the semiconductor relay S1, and protects the load circuit. Hence, at the point of time before the actual temperature of the electric wire W1 reaches the allowed temperature (for example, 150 degrees Celsius) as a result of that the overcurrent flowed through the loads 11, the circuit can be surely broken, and the electric wire W1 and the load 11 provided on the downstream side thereof can be protected. Therefore, it is not necessary to use the conventional fuses.

Moreover, unlike the conventional fuses, no deterioration occurs owing to the rush currents and the repetition of the ON/OFF of the loads, and it is not necessary to ensure the margin for the breaking temperature. Therefore, the diameter of the electric wire can be reduced, and the miniaturization and weight reduction of the electric wire can be achieved. Furthermore, an effect of improving fuel consumption can be eventually exerted.

Moreover, for the conventional fuses, fixed current values such as 5 amperes, 7.5 amperes, 10 amperes, 15 amperes and 20 amperes have been set. However, in the protection apparatus of the load circuit according to this embodiment, arbitrary current values (for example, 6 ampere, 12.5 ampere and the like) can be set. Therefore, the protection apparatus can be made to work on the reduction of the diameter of the electric wire.

Furthermore, in the protection apparatus of the load circuit according to this embodiment, the temperature estimation methods are used. Therefore, the protection apparatus can be applied not only to a load circuit having a configuration in which one fuse is provided with respect to one load, but also to a system in which a plurality of branched loads are connected to the downstream side, and to a load circuit in which the ON/OFF of the load is performed at random timing.

The description has been made above of the protection apparatus of the load circuit according to the present invention based on the illustrated embodiment. However, the present invention is not limited to this, and the configurations of the respective portions can be substituted by those with arbitrary configurations having similar functions. For example, though the description has been made of this embodiment, for example, by taking as an example the load circuit mounted on the vehicle, the present invention is not limited to this, and can also be applied to other load circuits.

### INDUSTRIAL APPLICABILITY

The protection apparatus of the load circuit is extremely useful for protecting the electric wire without using the fuse for use in the load circuit.

1. A protection apparatus of a load circuit that supplies, to a load, electric power outputted from a power supply and drives the load, the protection apparatus being for breaking the load circuit when an electric wire temperature of the load circuit has risen, comprising:
a timer that counts an elapsed time;
a current detection device that detects a current flowing through an electric wire on a downstream side thereof;
a switch device that switches connection and breaking of the electric power to the load circuit;
a temperature estimation device that estimates the electric wire temperature based on a value of the current detected by the current detection device and on the elapsed time counted by the timer; and
a breaking control device in which a threshold temperature is set at a value lower than an allowed temperature of the electric wire for use in the load circuit, the breaking control device breaking the switch device in a case where the current detected by the current detection device has become equal to or larger than a reference current value and the estimated temperature has reached the threshold temperature.

2. The protection apparatus of a load circuit according to claim 1, wherein the breaking control device turns the switch device to a connection-enabled state in a case where the temperature estimated by the temperature estimation device has dropped to an ambient temperature or lower after the switch device was broken.

3. The protection apparatus of a load circuit according to claim 1, wherein the threshold temperature is set at a lower temperature than an allowed temperature of an electric wire of which diameter is thinner by one level than a diameter of the electric wire for use in the load circuit.

4. The protection apparatus of a load circuit according to claim 1, wherein the threshold temperature is set at a temperature located between a minimum breaking temperature and maximum breaking temperature of a fuse to be used for protecting the electric wire for use in the load circuit in a range where the current reaches a current value equal to or larger than the reference current value.

5. The protection apparatus of a load circuit according to claim 1, wherein an arithmetic expression when the breaking control device calculates the electric wire temperature is represented as,
[Math. 1]
T2=T1+I1²rR{1−exp(−t/CR)} (1)
[Math. 2]
T2=T1+I2²rR{exp(−t/CR)} (2)
in which the expression (1) is used at a time of heat generation, and the expression (2) is used at a time of heat radiation, where T1 is an ambient temperature (degree Celsius), T2 is an estimated temperature of the electric wire (degree Celsius), I1 and I2 are energization currents (ampere), r is an electric wire conductor resistance (ohm), R is a thermal resistance (degree Celsius/watt), C is a heat capacity (joule/degree Celsius), and t is a time (second).
